(19) United States
(12) Patent Application Publication
(10) Pub. No.: US 2003/0075896 A1
(43) Pub. Date: Apr. 24, 2003

(54) Travelling fitness machine for full body training

(76) Inventor: Bjorn Kohler, Winsen (DE)

Correspondence Address: Rocco S Barrese, Dilworth & Barrese, 333 Earle Ovington Boulevard, Uniondale, NY, 11553, US

(21) Appl. No.: 10/049,029

(22) PCT Filed: Jun. 8, 2001
(86) PCT No.: PCT/EP01/06498

(30) Foreign Application Priority Data
Jun. 10, 2000 (DE) 200 10 464.0

(51) Int. Cl. B62M 1/14

(52) U.S. Cl. 280/242.1

(57) ABSTRACT

The invention concerns a riding fitness machine for full-body training. In accordance with the invention, a force for muscle training that is typically linearly directed is converted by means of a so-called pantograph into torques used for driving, where the freely movable end (force arm) of the pantograph is movable by the operator in one dimension or two dimensions.

### SUMMARY

The invention concerns a riding fitness machine for full-body training. In accordance with the invention, a force for muscle training that is typically linearly directed is converted by means of a so-called pantograph into torques used for driving, where the freely movable end (force arm) of the pantograph is movable by the operator in one dimension or two dimensions.

The invention concerns a riding fitness machine for full-body training Conventional-design fitness machines are generally in fixed locations in fitness studios or in the residence of a user. The energy expended by the user is still so-to-speak “wasted.”

In addition to this, individual machines for different muscle groups are combined into complete stations. In this connection, each individual machine provides only one direction of motion for training.

Each individual muscle group (agonist) is also trained individually, that is without stressing its opposing muscle groups (antagonists) with reversed movement sequences.

In addition to this, in order to train all muscle groups of a person, previous fitness machines would require a known high mechanical and equipment expense.

There have long existed stationary simple devices which permit only certain, relatively few, different exercises, but they never train all muscle groups and even then only to a small extent, although their advertising states otherwise.

The bicycles known generally as “outdoor fitness devices” or rowboats indeed serve for riding, but provide training by stressing only some individual muscle groups, for example, on the bicycle the leg stretching muscles are trained, or in the rowboat, the arm bending muscles, the leg extending muscles and the back are trained.

Also known is a “rowing bicycle” from the USA, which almost transfers the motions typical of rowing to the street and is relatively complicated to manage, because it must be held vertical by means of the balance of the rider. With this device, as well, only agonists are trained, and, as a maximum, only those that are stressed when rowing a boat.

Training machines for the disabled (called “hand bikes”) can be moved only by means of cranks. Wheelchairs with connecting rod drives, indeed, provide two directions of motion, but only in one plane of movement, therefore only a monotonous “back-and-forth” motion. Furthermore, these are not fitness devices.

Furthermore, on previous fitness machines, only one person can train using its full power per machine or per station. Incentives and competition directed to the relative strength of the trainees is practically impossible.

The problem to be solved by this invention is to create a fitness machine that uses training energy for locomotion, so as to provide the highly regarded “fun and fresh air,” where, with the machine, all muscle groups of the human body can be trained with the lowest possible equipment expense and without the time-wasting conversion work found with the previously known movement sequences of strength training. Simultaneously, it should be made possible to provide an incentive and an immediately comparable competition (similar to bicycle racing or rowboat racing) for the relative strength and stamina of the persons training.

In accordance with the invention, this problem is solved by means of a fitness machine with the characteristics of claim 1. Preferred embodiments of the fitness machine in accordance with the invention are shown in sub-claims 2 through 18.

With this fitness machine, it is not only the problems posed at the beginning that are solved. The fitness machine can be used by almost any body size or body shape without adaptation or conversion in an advantageous manner.

The new machine can provide aerobic and anaerobic as well as isometric training. The fitness machine is to be used and controlled in such a manner that the person training can concentrate on his training even at full speed, without having to exercise balance.

Similarly, the machine trains both agonist and antagonists in each exercise, in each individual repetition (complete lunge movement, for example, “lat pulling” and “pressing” and “biceps curl” and triceps curl”).

At the same time, a coasting function is provided, so that the person training can, as needed, coast the machine downhill, or can coast before stopping, or in the case of short breaks.

Using this fitness machine, disabled persons can also train more muscles than previously with hand bikes.

Using the brakes that are provided, the vehicle can be stopped slowly or even in an emergency with little strength.

The machine can be made to break down easily, and therefore is transported easily and stored compactly.

The machine can be controlled on at least three wheels, like a tricycle, or on four wheels, like an automobile, and with foot or body weight steering by the person sitting on it. Since the force exercised by the person in training is used for locomotion, so-called “outdoor training” is possible.

The speed that can be reached and the range are determined not solely by the muscle mass, but rather from the relative strength and Stamina of the person training Thus; even people of different body sizes and mass may enter into competition with each other.

A linkage in the shape of a pantograph, that is a scissors-grid-type linkage that is called in the claims a pantograph, drives the fitness machine only forward upon each training movement, regardless of direction and displacement, in cooperation with a rotational direction rectifier. This assures the agonist-antagonist training in each exercise repetition, even for persons of different body size.

The mechanical system of the fitness machine can also roll when the pantograph-type driving linkage is not moved. This can be attributed to the coasting mechanism provided.

The fitness machine can be driven with a low level of force and can be braked safely, since the gear ratio of the wheel drives can be shifted with even a small amount of force or the brakes of the fitness machine can be activated. The shifting of the ratio of the wheel drives makes it possible to achieve a slower or faster speed with the same displacement movement of the pantograph-type driving linkage.

As a result of the pantograph-type driving linkage, almost any one- or two-dimensional movement of the power arm in almost any position can be converted, through the rotational direction rectifier, into forward movement. As a result, any force vector significant for full-body training for persons of differing body size can be represented without conversion or readjustment.

The adjustable gear ratio has the effect that the machine—depending upon the inclination of the road or according to wind resistance or according to training requirements—can be moved faster with more force exertion or slower with less force exertion.

Similarly, the quick disconnect fasteners on the wheels, the folding mechanism of the frame and the folding back of the seat promote the uncomplicated disassembly of the machine and therefore compact storage and easy transport.

The springy, shock absorbing suspension of the wheels serves to enhance riding and therefore also training comfort.

A lap seatbelt can be attached to the seat so that the person training can train the latissimus dorsi (with gymnastic movements) according to his maximum strength without having to limit his application of power to his body weight.

The seat can be fastened so as to roll in the direction of travel. Foot straps can be mounted on the pedals so that the person training can, for example, use his leg bending muscles to move forward in the case of (reversed) rolling motions. The lap belt and foot straps also serve to secure the seat of a handicapped person (with crippled legs). In any event, the seat is movable only in the direction of travel and the machine is controlled by means of body weight by tilting the seat along the longitudinal axis.

The handgrip on the power arm of the pantograph-type driving linkage can be installed with different degrees of bending and different lengths in order to meet the various exercise requirements. The handgrips that are not being used are always carried along fastened to clamping devices on the frame of the machine.

The above-stated characteristics and advantages provide various applications for the fitness machine:

Alternative fitness machine for “outdoor training” for anyone who wishes to tone his body and lose weight.

Street rowing machine as a replacement for water rowing machines.

Endurance training machine for serious athletes.

Machine for cross and alternative training for any athlete.

A sports machine for handicapped persons as a supplement to previous types of handicapped sports.

Convalescent sports machine.

A new type of competitive racer.

Further details and advantages of the invention are explained in greater detail using the following sample embodiments of the invention.

1st Sample Embodiment: The training party carries out “double rowing training”

In one direction of motion, the person training pulls on the handgrip of the pantograph-type driving linkage, bracing his legs on the pedals, in order to push the rolling seat rearward. This provides training effect to the arm bending muscles, the entire back and the leg stretching muscles.

In the opposite direction of motion, he pushes the handgrip, moves the upper body forward and, with his leg bending muscles, pulls the seat forward and then moves his upper body rearward. Here, the arm stretching muscles, chest, lower abdomen and leg bending muscles are trained.

2nd Sample Embodiment: Depending upon the grip (back of the hand or comb grip), the person training trains the outer and inner parts of the biceps and triceps

In one direction of motion, he pulls on the handgrip of the pantograph-type driving linkage and places his legs against the pedals. As a result, especially bending muscles, and to a lesser extent back and leg stretching muscles, are trained.. In the opposite direction, he pushes the handgrip. As a result, especially the arm stretching muscles, and to a lesser extent chest and lower abdomen as well as leg bending muscles, are trained.

3rd Sample Embodiment: The person training trains similarly to gymnastics and “pressing”

In one direction of motion, the person training pulls on the handgrip of the pantograph-type driving linkage from above downward, therefore pressing the extended pantograph-type driving linkage together and downward, while he is held in the seat with the lap belt. Here, the arm bending muscles and especially the latissimus are trained.

In the opposite movement, he pushes the handgrip upward, therefore pulling the pantograph-type driving linkage back apart. As a result, the arm stretching muscles and especially the front and upper shoulder muscles are trained.

4th Sample Embodiment: The person training trains similarly to the so-called “slanted bench pull” and the “bench press”

In one direction of motion, he pulls the handgrip of the pantograph-type driving linkage from diagonally upward toward his chest, where he is held in the seat by the lap belt. As a result, the arm bending muscles and especially the latissimus as well as the lower abdomen are trained.

In the opposite movement, he pushes the handgrip obliquely upward and forward, as a result of which the arms stretching muscles and especially chest and the front shoulder muscles are trained.

5th Sample Embodiment: The person training trains similar to the “pull-on” and “tearing”

The person training keeps his arms stretched. In one direction of motion, he pulls the handgrip of the pantograph-type driving linkage from above forward, therefore pressing the stretched pantograph-type driving linkage together and forward while being held in the seat with the lap belt. Through this, the latissimus, the chest musculature and the rear shoulder musculature are trained.

In the opposite motion, he presses/pulls the handgrip back upward, with his arms still stretched out, therefore pulling the pantograph-type driving linkage apart again. As a result of this, the front and side shoulder musculature, as well as the trapezius, is trained.

In all exercises, the subject stresses almost the entire body, because the handgrip of the pantograph-type driving linkage is freely movable in two directions and converts almost any exercise motion into forward drive, which is equivalent to a training with free weights.

In the following, further exercise examples amount to embodiments are reflected. Depending on direction of motion and depending upon the handgrip used, all exercises can be carried out and refined in their performance.

On the basis of the coasting effect of the machine, the subject—to the extent he wishes—can also training only agonists, by actively and powerfully carrying out a movement in one direction (with the effect of forward motion), but then, with the movement in the opposite direction, moving the handgrip more slowly back to the starting position.

Even isometric training can be carried out easily if the subject tenses the muscles to be trained isometrically (and holds them in their position) and moves the machine with all other-muscles.

An example of this: The handgrip is held with the arms at chest height and fixed (isometric training for arms, shoulders, upper back and chest). With the legs and the lower back and abdomen, the person training holds and pushes the seat backwards and forwards.

In the same manner, the machine can be used as follows for aerobic (stamina) and anaerobic (maximum strength) training:

For aerobic training, the subject rides with relatively low application strength and therefore at a moderate speed. In this manner, he can travel long distances and therefore carries out very many “exercise repetitions.”

In anaerobic training, he rides with full exertion of strength until he is tired, indeed rapidly, but only for a short stretch, then pauses (coasting) and repeats this training over and over.

It can be concluded from what is mentioned above and from prior experience, that a warm-up training can be combined immediately with maximum strength training and/or with stamina training without the necessary of converting or leaving the machine.

It can also be concluded from what is stated above and from prior experience that the machine is suitable both for beginners and for tour riders, since at medium speeds of 10 to 15 km/h distances of 20 to 30 km can be traveled effortlessly.

Further details and advantages of the invention are explained on the basis of a sample embodiment represented in the drawing. The following are shown:

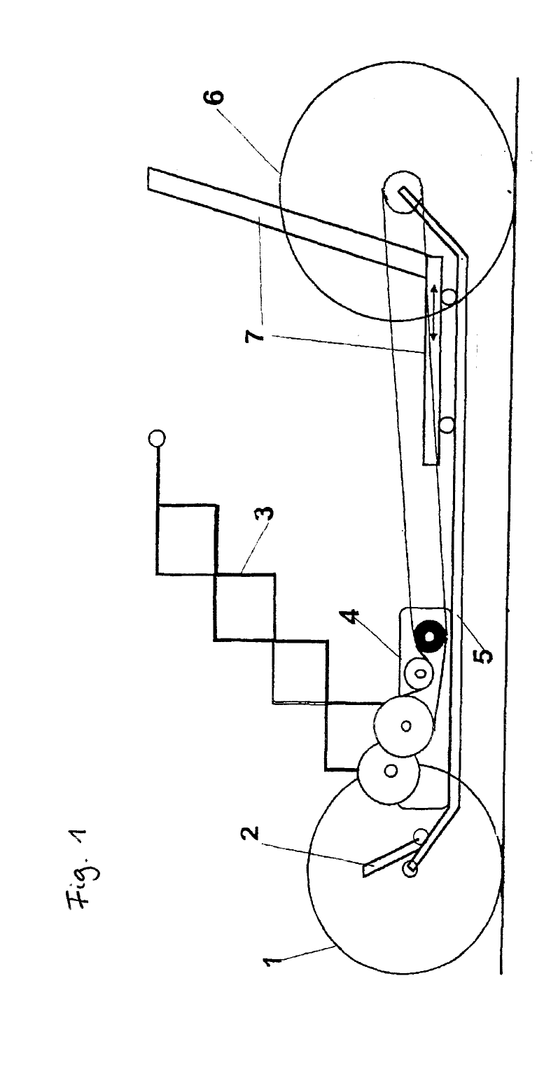

FIG. 1: a schematic representation of the riding fitness machine in accordance with the invention and

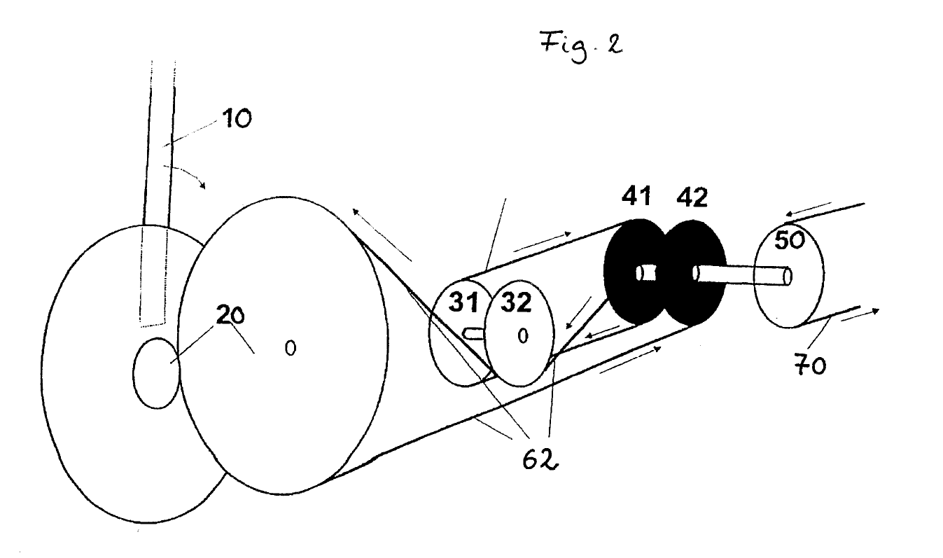

FIG. 2: the schematic representation of a rotational direction rectifier of the riding fitness machine in accordance with FIG. 1 in detail.

In FIG. 1, 1 represents a joint on the front axle that can be steered by means of two steering pedals 2.3 shows a pantograph-type driving linkage with handgrip, which works together with a shiftable wheel drive 4 with rotational direction rectifier. The frame 5 of the fitness machine is represented here only greatly simplified. In the rear area of the frame, there are two rear wheels 6 and an integrated transmission. A seat 7 is placed in such a manner that it can roll or, if appropriate, so that it can rock for control by a handicapped person. The seat has a folding back that is not shown in greater detail.

On the basis of FIG. 2, especially the effect of the shiftable wheel drive 4 with rotational direction rectifier can be explained. The lower arm of the pantograph-type driving linkage 3 is here designated as pantograph-type driving linkage arm 10 and is moved, for example, by the rowing motion (“pull”) clockwise, so that the drive wheel connected to the load arm of the wheel drive 20 also moves clockwise. 31, 32, 41 and 42 designate sprocket wheels of the rotational direction rectifier. The first sprocket wheel 31 of the rotational direction rectifier is connected solidly by its shaft to the second sprocket wheel 32, while the first sprocket wheel is connected through a subsidiary chain 61 in the same direction to a sprocket wheel 41. The second sprocket wheel of the rotational direction rectifier is connected by means of a main chain 62, which also runs in the opposite direction through the wheel drive 20, to the sprocket wheel 42. Both the third sprocket wheel 41 and the fourth sprocket wheel 42 are connected through a clamp roll clutch and shaft in the same direction to a sprocket wheel 50, which is simultaneously the drive wheel of the rotational direction rectifier, which are connected through a chain 70 to the rear wheels 6 (not represented in FIG. 2).

The function of this wheel drive results from the fact that the wheel drive 20 converts the relatively small rotation that is introduced by the pantograph-type driving linkage arm 10 into the wheel drive 20, due to multiple rotations of the sprocket wheel 50 of the wheel drive, where the rotational direction is simultaneously reversed.

The sprocket wheels 31 and 32 now rotate clockwise as a result of the chain position of the main chain 62.

The sprocket wheel 42 rotates counter clockwise, the associated clutch engages and through a shaft rotates the sprocket wheel 50, which moves the machine forward.

The clutch of the sprocket wheel 41 turns freely because the sprocket wheel 41 is currently rotating counter to the direction of sprocket wheel 42, because it is rotated clockwise through the auxiliary chain 62 by the sprocket wheel 31.

If the pantograph-type driving linkage arm 10 is moved counter clockwise (for example, in the case of “push”), the sprocket wheels 31 and 32 also rotate counter clockwise.

The clutch in 41 now engages and drives the sprocket wheel 50. The clutch in 42 now runs free, because 42 is rotating clockwise.

Thus, the sprocket wheel 50 always “forward” and the clutches assure coasting for “training breaks,” described above in greater detail.

1. Riding fitness machine for full-body training, characterized in that,
the conversion of the typically linearly directed forces for muscle training into torques used for drive is done by means of a pantograph, whose freely movable end can be moved in one or two dimensions.

2. Fitness machine according to claim 1, characterized in that, a pantograph has an end (load arm), which performs only resulting angular motions and is solidly fixed to a wheel drive at the center of gravity.

3. Fitness machine, characterized in that, the drive wheel driven by the pantograph is connected to a drive wheel through a transmission.

4. Fitness machine, characterized in that, the conversion of both rotational directions of the drive wheel associated with the wheel transmission, which results from the angular motion direction of the pantograph, is achieved by means of a rotational direction rectifier.

5. Fitness machine according to claim 4, characterized in that, the rotational direction rectifier consists of a system of two pinch roll clutches connected to each other in the same direction but driven in opposite directions.

6. Fitness machine according to claim 5, characterized in that, the pinch roll clutches of the rotational direction rectifier make it possible for the entire machine to coast.

7. Fitness machine according to one of the claims 1 through 6, characterized in that, the direction and the starting point of the force vectors determined by the training can be chosen at random.

8. Fitness machine according to one of the claims 1 through 7, characterized in that, the machine is supported on three or four wheels.

9. Fitness machine according to one of the claims 1 through 8, characterized in that, the riding direction of the machine can be controlled with the feet or shifting of body weight of the rider sitting on it.

10. Fitness machine-according to one of the claims 1 through 9, characterized in that, the transmission ratio of the wheel drive is selectable.

11. Fitness machine according to one of the claims 1 through 10, characterized in that, the two rear wheels can be braked independently by means of manual power.

12. Fitness machine according to one of the claims 1 through 11, characterized in that, the seat of the machine is supported so that it can be tipped and is connected to the steering by means of a shaft with universal joint.

13. Fitness machine according to one of the claims 1 through 12, characterized in that, the seat of the machine is mounted in such a manner as to be movable and rolling in the direction of travel.

14. Fitness machine according to one of the claims 1 through 13, characterized in that, the seat as well as the pedals are provided with straps.

15. Fitness machine according to one of the claims 1 through 14, characterized in that, the seat back can be adjusted and folded.

16. Fitness machine according to one of the claims 1 through 15, characterized in that, the frame of the fitness machine can be folded together.

17. Fitness machine according to one of the claims 1 through 16, characterized in that, the wheels of the machine can be attached by means of quick disconnect attachments.

18. Fitness machine according to one of the claims 1 through 17, characterized in that, the frame of fitness machine can be folded together.
